(19) United States
(12) Patent Application Publication
(10) Pub. No.: US 2022/0379505 A1
(43) Pub. Date: Dec. 1, 2022

(54) SHAVERS AND METHODS

(71) Applicant: BIC Violex Single Member S.A., Anoixi (GR)

(72) Inventor: Michail KOKOZIDIS, Anoixi (GR)

(73) Assignee: BIC Violex Single Member S.A., Anoixi (GR)

(21) Appl. No.: 17/664,294

(22) Filed: May 20, 2022

(30) Foreign Application Priority Data
May 28, 2021 (EP) 21176622.5

(51) Int. Cl. B26B 19/38

(52) U.S. Cl. CPC B26B 19/388; B26B 19/3853

(57) ABSTRACT

A shaver comprises at least one hyperspectral imaging sensor configured to capture spectral information for at least one area of skin scanned by the shaver. A computer-implemented method for skin monitoring comprises obtaining spectral information for at least one area of skin scanned by a shaver and storing the spectral information for the at least one area of skin scanned by the shaver. A shaver kit comprises the shaver and an electronic device configured for data exchange with the shaver and configured to run the computer-implemented method for skin monitoring.

### CROSS REFERENCE TO RELATED APPLICATION(S)

This application claims priority from the European patent application EP21176622.5, filed on May 28, 2021, its content being incorporated herein by reference.

### TECHNICAL FIELD

This specification relates to a shaver, a computer-implemented method for skin monitoring, a shaver kit and a server.

### BACKGROUND

(Hyper)spectral imaging (HSI) sensors collect and process information from across the electromagnetic spectrum (or from across a portion thereof). Hyperspectral imaging sensors may be configured to obtain such information for each pixel of an image of a scene to be captured and/or analyzed. Recorded spectra (for each pixel) may have rather fine wavelength resolution and cover a wide range of wavelengths. In particular, hyperspectral imaging sensors may measure (quasi-)continuous spectral bands. Alternatively, recorded spectra may feature spaced spectral bands (also referred to as multiband imaging). As examples, the additional spectral dimension may be beneficial for finding hidden objects underneath a surface (e.g. a sketch under a painting), to identify materials/textures of an object, and/or to detect processes within an object. In particular, hyperspectral imaging may be used in cases where objects to be analyzed are out of reach or shall not be destroyed.

Hyperspectral imaging may be used in medical imaging. As an example, it may be used as a computer aided means to diagnose skin related issues and/or diseases (e.g. types of skin cancer).

In recent years, hyperspectral imaging sensors have evolved towards miniaturization and may now also be used in weight sensitive applications such as e.g. unmanned aerial vehicles (UAV) and/or nano-satellites. Miniaturization may be accompanied by reduction(s) in size, weight and/or power consumption. Furthermore, durable and washable hyperspectral imaging sensors are being developed in order for them to be embedded in wearable technologies.

### SUMMARY

According to a first aspect, there is provided a shaver comprising at least one hyperspectral imaging sensor configured to capture spectral information for at least one area of skin scanned by the shaver.

According to a second aspect, there is provided a computer-implemented method for skin monitoring comprising obtaining spectral information for at least one area of skin scanned by a shaver—or the shaver according to the first aspect (or an embodiment thereof)—and, optionally, storing the spectral information for the at least one area of skin scanned by the shaver.

According to a third aspect, there is provided a shaver kit comprising the shaver according to the first aspect (or an embodiment thereof) and an electronic device configured for data exchange with the shaver. Optionally, the electronic device may be configured to run the computer-implemented method for skin monitoring according to the second aspect (or an embodiment thereof).

According to a fourth aspect, there is provided a server in a network configured to run the computer-implemented method for skin monitoring according to the second aspect (or an embodiment thereof).

Dependent embodiments of the aforementioned aspects are given in the dependent claims and explained in the following description, to which the reader should now refer.

In general, hyperspectral imaging (HSI) may be used as a computer aided means in dermatology to monitor skin conditions. For example, the hyperspectral imaging (HSI) may be used to diagnose (e.g. to recognize and/or assess) skin related issues and/or diseases. For example, a skin related issue may relate to a state of skin hydration. Alternatively, or in addition, the skin related issue may relate to a (benign) mole. Alternatively, or in addition, the skin related issue/disease may relate to a lesion and/or inflammation of the skin. As another example, a skin related disease may be a type of skin cancer such as e.g. a (malignant) melanoma.

The spectral information may provide a third dimension to a two-dimensional scene capturing an area of skin scanned by a (portable) skin scanner. The one or more of the skin related issues and/or diseases may manifest themselves in terms of certain patterns (also: fingerprints or spectral signatures) in the spectral information. As an example, computer-implemented machine learning algorithms may be trained to recognize such patterns, thereby learning to predict and assess skin related issues and/or diseases. In some cases (e.g. in case of a malignant melanoma) an early diagnose of a skin related issue and/or disease may be critical to a cure. Patients (e.g. in a given risk class) are therefore sometimes advised to undergo regular medical skin monitoring.

Conventionally, regular medical skin monitoring is (only) provided by a medical practitioner and/or a dermatologist. Each such examination typically requires an appointment accompanied by a certain amount of expenditure for the patient and costs (whoever has to bear them). In fact, medical skin monitoring is often—depending on the individual risk of the patient, the health system and/or coverage of costs—less frequent than e.g. quarterly, half-yearly, yearly or biennial. As a result, quickly evolving skin related issues and/or diseases may be missed in between medical skin monitoring examinations. While some medical practitioners/dermatologists try to raise awareness for possible skin related issues and/or diseases—in particular, for rapidly changing anomalies and/or artifacts—patients are often incapable of and/or reluctant to self-examining or being examined by a partner on a (more) regular basis. Along the same lines, skin related issues and/or diseases may be missed in cases where medical skin monitoring does not even occur in regular intervals or does not take place at all.

The solution of this specification proposes a portable skin scanner that—thanks to advancements in miniaturization of hyperspectral imaging sensors—is integrated into the shaver of the first aspect (or an embodiment thereof). In so doing, self-examining for skin monitoring is integrated into a frequent and/or common habit (e.g. daily, every 2 days, every three days, weekly). As a result, in embodiments of the computer-implemented method for skin monitoring of the second aspect a large amount of skin monitoring data may be generated and stored. Such skin monitoring data may relate to the appearance (e.g. from red, green, blue in the spectral information for each pixel of the at least one hyperspectral imaging sensor) and composition/texture/structural data (e.g. from spectral information going beyond red, green, blue). For documentation purposes the skin monitoring data may be timestamped. Collecting skin monitoring data does not require seeing a medical practitioner and/or dermatologist. In fact, it may promote telemedicine.

The large amount of skin monitoring data may be used to complement the regular medical skin monitoring, thereby supporting the medical practitioner/dermatologist in diagnosing skin related issues and/or diseases. In this case, an embodiment of the server of the fourth aspect providing a user interface may be beneficial for data exchange between the patient and the practitioner/dermatologist.

Alternatively, or in addition, and as in embodiments of the computer-implemented method for skin monitoring of the second aspect, the skin monitoring data from the shaver may be used to analyze the at least one area of skin scanned by the shaver. As an example, such an analysis may be carried out by the electronic device of the shaver kit of the third aspect (or an embodiment thereof). Alternatively, or in addition, the analysis (or a complementing analysis) may be carried out on the server of the fourth aspect (or an embodiment thereof).

Alternatively, or in addition, the skin monitoring data from the shaver may be uploaded on the server in order to be assessed by an expert (e.g. again a dermatologist providing telemedicine) or a more elaborate medical model/algorithm. The resulting pairings of skin monitoring data and corresponding labels in terms of skin related issues/diseases may be beneficial for improving future skin monitoring models/algorithms. As an example, such pairing data may be used as training data for future machine learning algorithms. Eventually, models/algorithms in the electronic device of the shaver kit may be updated, thereby improving the skin monitoring analysis.

Alternatively, or in addition, the skin monitoring data and, as an example, the analysis thereof may be used to generate a feedback trigger that is to be fed back to the shaver (or the user thereof) in case that an area of skin is deemed to need special attention. In so doing, a user action may be triggered. For example, the user of the shaver may then keep an eye on this particular area of skin, consult the electronic device (e.g. an app installed thereon) of the shaver kit of the third aspect (or an embodiment thereof) for further information and/or seek professional advice.

A skin related issue may also be related to cosmetics and skin care. In fact, as an example, the skin related issue may be a lack of hydration of the skin. In this case, the skin monitoring data may be used to indicate—e.g. via the feedback trigger, and if need be—applying hydration cream.

Integrating skin monitoring in the shaver allows for scanning areas of skin during shaving. On the other hand, it is by no means necessary to restrict scanning to shaving. In fact, the shaver (e.g. with or without a shaving head) may also be used for skin monitoring without shaving to account for typical cases where only some areas of skin shall be shaved.

### FIGURES DESCRIPTION

FIG. 1a shows an example shaving head skin adaptor of a shaver with four hyperspectral imaging sensors.

FIG. 1b shows an example shaving head skin adaptor of a shaver with two hyperspectral imaging sensors and two further sensors (e.g. skin hydration sensors).

FIG. 2 schematically illustrates an embodiment of a shaver according to the first aspect with at least one hyperspectral imaging sensor.

FIG. 3a-b schematically illustrate embodiments of the computer-implemented method for skin monitoring according to the second aspect.

FIG. 4 schematically illustrates an embodiment of the shaver kit according to the third aspect and/or of the server according to the fourth aspect.

FIG. 5 schematically illustrates a three-dimensional hyperspectral data cube with two spatial dimensions (x, y) spanning a scene of the at least one scanned area of the skin and one spectral dimension (λ) spanning a portion of the electromagnetic spectrum.

### DETAILED DESCRIPTION

The shaver 100 of the first aspect (or an embodiment thereof), the computer-implemented method 200 for skin monitoring of the second aspect (or an embodiment thereof), the shaver kit 300 of the third aspect (or and embodiment thereof) and the server 400 of the fourth aspect (or and embodiment thereof) provide means for regularly collecting skin related data through a frequent and/or common habit, resulting in a large amount of skin monitoring data that may be used for analysis and/or medical diagnosis.

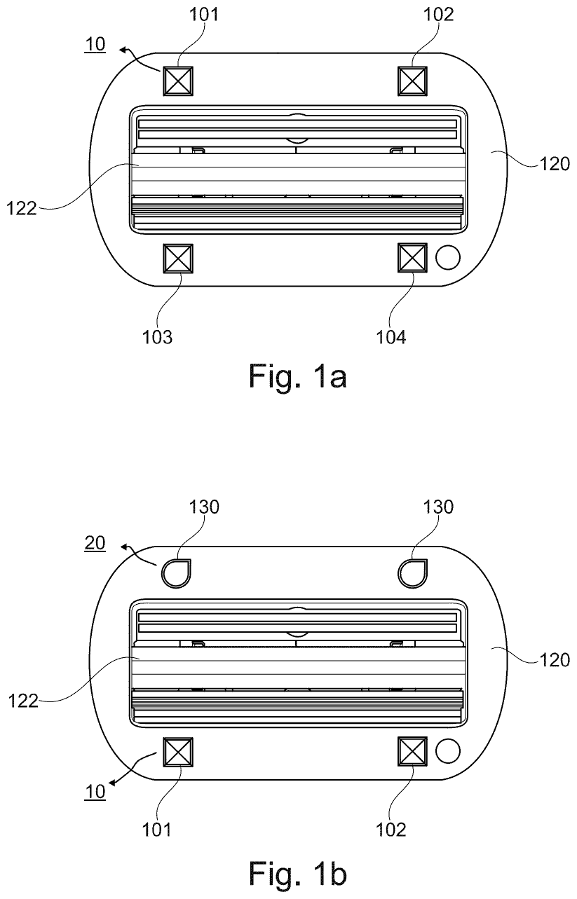

The shaver 100 comprises at least one hyperspectral imaging sensor 101 configured to capture spectral information 10 for at least one area of skin scanned by the shaver 100 (e.g. during use of the shaver 100). In FIG. 1a-b example shavers 100 (or rather example shaving head skin adaptors thereof, see below) with at least one hyperspectral imaging sensor 101 are shown.

The captured spectral information 10 allows for an analysis of appearance, composition and/or structural data of the at least one area of skin. Furthermore, the spectral information 10 may be used as a means for 3D probing beyond the surface of the at least one area of skin. Integrating skin monitoring in the shaver 100 allows for skin monitoring without or with little additional efforts and gives rise to a (long-term) history of skin monitoring data that may be beneficial for spotting and/or analyzing skin related issues and/or diseases (e.g. a melanoma). In general terms, skin artifacts may be spotted and/or analyzed based on the (long-term) history of skin monitoring data. In fact, skin artifacts may be any kind of localized or non-localized difference in the acquired skin monitoring data, as compared to the standards for the respective measurements as defined by medical studies and/or possible initial measurements on the user (e.g. prior to first use).

The spectral information 10 for the at least one area of skin scanned by the shaver 100 may be captured with or without movement of the shaver 100 relative to the skin of a user of the shaver 100. Furthermore, depending on the HSI technology (e.g. spatial scanning, spectral scanning, snapshot, spatiospectral scanning, . . . ) used, spectral information may be captured for a sequence of one or more contiguous and/or overlapping areas of skin (comprising the at least one area of skin), in particular, when stroking the shaver over the skin.

Scanning by the shaver 100 may or may not be accompanied by shaving by the shaver 100, i.e. by removing body hair covering the skin. In fact, as an example, the shaver 100 may be used for scanning without a shaving head. As another example, the shaver 100 may be used for scanning with a shaving head but stroking in a direction opposite to the shaving direction (as defined by the configuration of blades in the shaving head).

As an example, the spectral information 10 (e.g. for the at least one area of skin scanned by the shaver 100) may comprise or be a three-dimensional hyperspectral data cube 12 (strictly speaking: a cuboid) with two spatial dimensions x, y spanning a scene of the at least one scanned area of the skin and one spectral dimension λ, spanning a portion of the electromagnetic spectrum. Such a cube is schematically illustrated in FIG. 5. In other words, the spectral information 10 may comprise or be a 3-tensor or 3-array. Alternatively, the spectral information 10 may comprise or be a map from the two spatial dimensions x, y spanning the scene of the at least one scanned area of skin and the one spectral dimension λ, spanning the portion of the electromagnetic spectrum onto the spectral frequency (or the spectral density).

As another example, the spectral information 10 (e.g. for the at least one area of skin scanned by the shaver 100) may comprise or be a set of images with two spatial dimensions x, y spanning a/the scene of the at least one scanned area of the skin, wherein each image represents (or is given in terms) a unique spectral band of the electromagnetic spectrum (e.g. multiband imaging). A (each) spectral band may be a narrow wavelength range of the electromagnetic spectrum. A (each) spectral band may be unique, if it does not overlap with any other spectral band. A spectral band may e.g. be narrow in the sense that the width of the spectral band is small as compared to a spacing between spectral bands. However, the spectral bands may or may not be spaced within the electromagnetic spectrum. The spectral information 10 may comprise at least four spectral bands of the electromagnetic spectrum, e.g. as in the three-dimensional hyperspectral data cube 12 depicted in FIG. 5. In this case, as an example, the spectral information 10 may go beyond red/green/blue (RGB) as in standard imaging in the visible spectrum. As further examples, the spectral information 10 may comprise ≥5, ≥6, ≥7, ≥8, ≥9, ≥10, ≥15, ≥20, ≥50, ≥100 spectral bands. The discretization ranges in the spectral dimension for the three-dimensional hyperspectral data cube 12 may or may not be in one-to-one correspondence with the spectral bands.

Furthermore, at least one spectral band of the electromagnetic spectrum comprised by the spectral information 10 may be in the ultraviolet (e.g. wavelengths between 10 nm to 400 nm).

Alternatively, or in addition, at least one spectral band of the electromagnetic spectrum comprised by the spectral information 10 may be in the visible spectrum (e.g. as perceived by the human eye, e.g. electromagnetic radiation with wavelengths in the range of 400 nm to 700 nm). Alternatively, or in addition, at least one spectral band of the electromagnetic spectrum comprised by the spectral information 10 may be in the infrared (e.g. wavelengths between 700 nm and 1 mm). Ultraviolet and/or infrared radiation may enhance the skin monitoring analysis.

The spectral information 10 (e.g. for the at least one area of skin scanned by the shaver 100) may be continuous or quasi-continuous (e.g. a multiplicity of contiguous narrow spectral bands).

The spectral information 10 for the at least one area of the skin scanned by the shaver 100 may be configured for analyzing a state of the at least one area of the skin. As an example, the state of the at least one area of the skin to be analyzed may comprise or be a measure of the hydration of the at least one area of the skin. In this case, at least one further sensor 130 for measuring hydration may be integrated in the shaver 100, see e.g. FIG. 1b. Alternatively, or in addition, the state of the at least one area of the skin to be analyzed may comprise or be an anomaly status of the at least one area of the skin. As an example, the anomaly status may be a score assessing a skin related issue and/or disease (in general: a skin artifact) such as, for example, a lesion or inflammation, a (benign/malignant) mole, or a (malignant) melanoma.

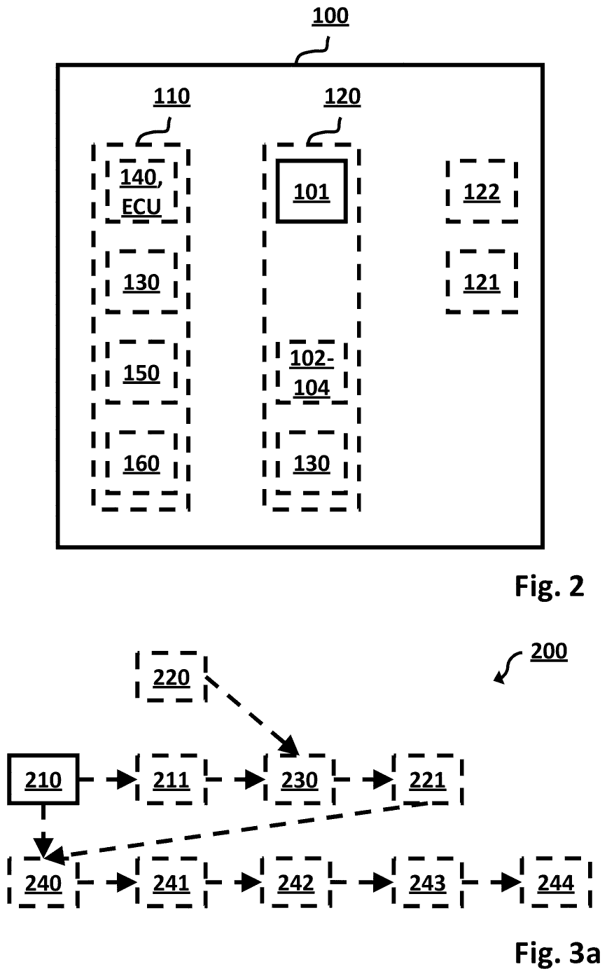

The at least one hyperspectral imaging sensor 101 may be further configured to capture spectral information 10 for the at least one area of the skin scanned by the shaver 100 while being used for shaving (body hair covering the skin). To this end, as schematically illustrated in FIG. 2, the shaver 100 may comprise a shaver handle 110. The shaver 100 may further comprise a shaving head holder 121 configured to be pivotably connected to a shaving head 122 and configured to be coupled (e.g. via an clip-on mechanism, see below) to the shaver handle 110. The shaver 100 may further comprise a shaving head skin adaptor 120 configured to be coupled (e.g. via a further clip-on mechanism, see below) to the shaving head 122. The shaving head skin adaptor 120 may comprise the at least one hyperspectral imaging sensor 101 e.g. in a nest, i.e. in a recess of the shaving head skin adaptor 120. The shaver 100 may or may not comprise the shaving head 122. Integrating the hyperspectral imaging sensors 101-104 in the shaving head skin adaptor 120 (and not in the shaving head 122) allows for ideal positioning of the hyperspectral imaging sensors close to the skin to be scanned. Furthermore, while the shaving head 122 is typically to be replaced, when the blades are worn-out, the shaving head skin adaptor 120 may or may not be replaced. In fact, the shaving head skin adaptor 120 may be independent of replacement of the shaving heads 122. This may reduce costs and save resources.

The shaving head holder 121 and the shaver handle 110 may be configured so as to comprise a clip-on mechanism that allows both for coupling (also: locking) the shaver handle 110 to the shaving head holder 121 and for decoupling (also: unlocking; e.g. without destruction) the shaver handle 110 from the shaving head holder 121. The clip-on mechanism allows for and/or supports easy removal or addition of shaving heads, e.g. to apply the shaver 100 to scan an area of skin for skin monitoring that shall not be shaved.

The shaving head skin adaptor 120 and the shaving head 122 may be configured so as to comprise a further clip-on mechanism that allows both for coupling (also: locking) the shaving head skin adaptor 120 to the shaving head 122 and for decoupling (also: unlocking; e.g. without destruction) the shaving head skin adaptor 120 from the shaving head 122. The further clip-on mechanism allows for easy replacement of shaving heads 122 while e.g. reusing the shaving head skin adaptor 120. Furthermore, the further clip-on mechanism allows for easy removal or addition of shaving heads, e.g. to apply the shaver 100 to scan an area of skin for skin monitoring that shall not be shaved.

The at least one hyperspectral imaging sensor 101 may be embedded e.g. in a nest, i.e. a recess, in the shaving head skin adaptor 120 and may face the skin to be shaved by the shaver 100. Alternatively, the at least one hyperspectral imaging sensor 101 or other hyperspectral imaging sensors 102-104 (e.g. each in a corresponding nest) may each be oriented in a corresponding angle towards the skin to be shaved by the shaver 100. In case of a plurality of hyperspectral imaging sensors 101-104, the hyperspectral imaging sensors 101-104 may be oriented (differently) so as to cover the same volume underneath the skin generating a stereo effect in the spectral information 10 that may enhance the skin monitoring analysis. Alternatively, the at least one hyperspectral imaging sensor 101 or another hyperspectral imaging sensor 102-104 may be in another part of the shaver 100. Such may be used e.g. for overview imaging that may facilitate/support mapping the spectral information 10 on locations on the body.

The shaver 100 may comprise a plurality of hyperspectral imaging sensors 101, 102, 103, 104—e.g. 2, 3, 4, or more than 4 hyperspectral imaging sensors—configured to capture spectral information 10 for the at least one area of skin or a plurality of areas of skin scanned by the shaver 100. The plurality of the hyperspectral imaging sensors 101, 102, 103, 104 may comprise the at least one hyperspectral imaging sensor 101. The shaving head skin adaptor 120 may comprise the plurality of the hyperspectral imaging sensors 101, 102, 103, 104.

Each hyperspectral imaging sensor 101, 102, 103, 104 (or some hyperspectral imaging sensors) of the plurality of the hyperspectral imaging sensors 101, 102, 103, 104 may be embedded in the shaving head skin adaptor 120 and faces the skin to be shaved by the shaver 100. The embedding may be such that the hyperspectral imaging sensors 101-104 come in proper distance to the skin in order for the optics of the sensor to properly receive the spectral information 10. The plurality of the hyperspectral imaging sensors 101, 102, 103, 104 may be positioned around the shaving head 122 (or around where the shaving head 122 would be located, when locked on the shaver head holder 121), as e.g. in FIG. 1a. The shaving head skin adaptor 120 may surround the shaving head holder 121 and/or the shaving head 122 at least partially (or completely, in a cross-sectional plane) and is sufficiently large in order for the plurality of the hyperspectral imaging sensors 101, 102, 103, 104 to be positioned around the shaving head 122 (or around where the shaving head 122 would be located, when locked on the shaver head holder 121). Thanks to the miniaturization of the hyperspectral imaging sensors, the shaving head skin adaptor 120 may still be reasonably sized (as needed for shaving).

As an example, each of the hyperspectral imaging sensors of the plurality of hyperspectral imaging sensors 101, 102, 103, 104 may be configured to capture spectral information for an area of skin scanned by this (particular) hyperspectral imaging sensor. Alternatively, the hyperspectral imaging sensors of the plurality of hyperspectral imaging sensors 101, 102, 103, 104 may be configured to capture spectral information for the at least one area of skin. As an example, and as shown in FIG. 1a, the hyperspectral imaging sensors 101 and 103 (or 102 and 104) may be arranged so as to capture spectral information for the same area of skin when stroking the shaver over the skin, albeit at different times during scanning/shaving.

At least one (or each; i.e. the at least one hyperspectral imaging sensor 101 or one hyperspectral imaging sensor of the plurality of hyperspectral imaging sensors 101-104) hyperspectral imaging sensor 101, 102, 103, 104 may comprise a sensing element comprising an array of pixels each configured to capture spectral information 10 of a scene to be sensed. Dimensions of the array of pixel may be at least 1×2 or 2×1 (not 1×1), i.e. at least one dimension may be greater than 1. At least one hyperspectral imaging sensor 101, 102, 103, 104 may further comprise an electronic sensor unit configured to collect and/or process the spectral information 10 captured by the corresponding pixels. At least one hyperspectral imaging sensor 101, 102, 103, 104 may further comprise an optical system for transferring the scene to be sensed onto the corresponding sensing element. As examples, the optical system may be a lens system and/or a diffractive optical element (DOE).

The shaver 100 may comprise one or more further sensors 130 configured to measure (e.g. while scanning/shaving) one or more of location of the shaver 100, orientation of the shaver 100, stroke movement, stroke resistance, skin contact, distance to the skin, temperature, humidity, skin hydration (see e.g. FIG. 1b. In fact, the one or more further sensors 130 may be configured to measure the location of the shaver 100. Alternatively, or in addition, the one or more further sensors 130 may be configured to measure the orientation of the shaver 100. Alternatively, or in addition, the one or more further sensors 130 may be configured to measure the stroke movement. Alternatively, or in addition, the one or more further sensors 130 may be configured to measure the stroke resistance. Alternatively, or in addition, the one or more further sensors 130 may be configured to measure the skin contact. Alternatively, or in addition, the one or more further sensors 130 may be configured to measure the distance to the skin. Alternatively, or in addition, the one or more further sensors 130 may be configured to measure the temperature. Alternatively, or in addition, the one or more further sensors 130 may be configured to measure the humidity. Alternatively, or in addition, the one or more further sensors 130 may be configured to measure the skin hydration. For example, a further sensor 130 may be a gyroscope. Alternatively, or in addition, a further sensor 130 may be a camera (e.g. CMOS, CCD). Alternatively, or in addition, a further sensor 130 may be a laser or a LIDAR. Alternatively, or in addition, a further sensor 130 may be a temperature sensor. Alternatively, or in addition, a further sensor 130 may be a humidity sensor. Data 20 measured by the one or more further sensors 130 may be used in the skin monitoring analysis. In particular, correlating the data 20 from the one or more further sensors with the spectral information may improve the analysis and may provide a mapping (e.g. a body landscape).

As an example, skin contact and/or stroke movement may be sensed by the one or more further sensors 130 and the at least one hyperspectral imaging sensor 101, 102, 103, 104 may be triggered to start capturing the spectral information 10 for the at least one area of skin scanned/shaved by the shaver 100, when skin contact and/or stroke movement has/have (just) been established. Such information may also be used for stroke counting. Furthermore, the at least one hyperspectral imaging sensor 101, 102, 103, 104 may be triggered to stop capturing the spectral information 10 for the at least one area of skin scanned/shaved by the shaver 100, when skin contact and/or stroke movement has/have (just) ceased. Again, such information may also be used for stroke counting. Capturing the spectral information 10 only when needed may save energy and avoid recording unimportant spectral information (e.g. in between scanning/shaving strokes).

The shaver handle 110 may comprise the one or more further sensors 130 or a subset thereof. On the other hand, the shaving head skin adaptor 120 may comprise the one or more further sensors 130 or a subset thereof, as in FIG. 1b.

The shaver 100 may comprise an electronic control unit ECU, 140 configured to power and control the at least one hyperspectral imaging sensor 101 (or each/some of the hyperspectral imaging sensors in the plurality of the hyperspectral imaging sensors) and to obtain the spectral information 10 from (the) at least one hyperspectral imaging sensor 101, 102, 103, 104. Furthermore, the shaver 100 or the electronic control unit ECU, 140 may comprise a communication interface 150 configured for data exchange with an electronic device 310 (e.g. of a shaver kit), wherein the communication interface 150 may be configured to transmit the spectral information 10 (e.g. along with corresponding timestamps, i.e. a time series of spectral information 10 while scanning/shaving) to the electronic device 310. The communication interface 150 may further be configured to transmit data 20 (e.g. along with corresponding timestamps, i.e. a time series of such data 20 while scanning/shaving) measured by the one or more further sensors 130. As examples, timestamps may be absolute or relative in time. For example, the communication interface 150 may be configured for data exchange according to a communication protocol/network such as e.g. WiFi, Bluetooth, NFC, 4G, 5G, 6G, internet, LAN. The electronic device 310 may serve further processing (e.g. analysis) and/or storage for (long-term) skin monitoring. Data exchange may be bidirectional (e.g. for sending feedback to the shaver 100 after analysis and in case that some area of skin needs attention). As an example, the shaver handle 110 may comprise the electronic control unit ECU, 140 and/or the communication interface 150.

The shaver 100 may comprise a feedback interface 160 configured to inform a user (e.g. the person inspecting/shaving herself/himself) of the shaver, upon receiving a feedback trigger 33, about an area of the skin that may need or is deemed to need attention. As an example, such an area of the skin may be a mole that is deemed to be anomalous and may be a malignant melanoma. The feedback interface 160 may be configured to provide optical, acoustic, and/or haptic feedback to the user of the shaver 100. In other words, the feedback interface 160 may be configured to provide optical feedback to the user of the shaver 100 (e.g. via at least one LED). Alternatively, or in addition, the feedback interface 160 may be configured to provide acoustic feedback to the user of the shaver 100 (e.g. via at least one speaker or beeper). Alternatively, or in addition, the feedback interface 160 may be configured to provide haptic feedback to the user of the shaver 100 (e.g. via a vibrating element). The shaver handle 110 may comprises the feedback interface 160 (or portions thereof). Alternatively, or in addition, the shaving head skin adaptor 120 may comprise the feedback interface 160 (or portions thereof). In such a case feedback may be delivered directly to the skin being scanned/shaved.

The shaver 100 may further comprise means (e.g. LED) for illuminating the at least one area of skin to be analyzed. As an example, such means may be comprised by the shaving head skin adaptor 120 and/or close to the hyperspectral imaging sensors 101-104. Illumination may enhance the quality of skin monitoring data, thereby eventually enhancing the skin monitoring analysis.

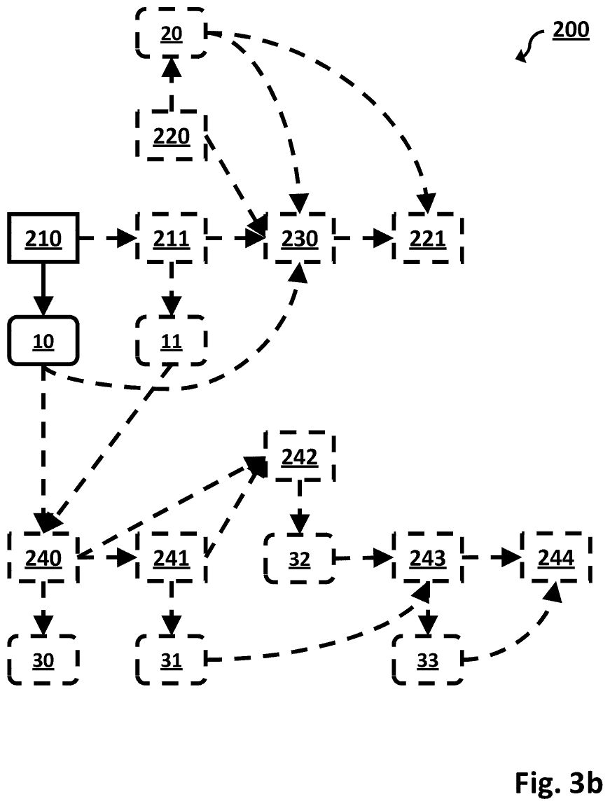

The computer-implemented method 200 for skin monitoring of the second aspect (or an embodiment thereof) comprises obtaining 210 (the) spectral information 10 (or a timeseries thereof) for (the) at least one area of skin scanned by a/the shaver 100. Scanning the at least one area of skin may or may not involve shaving the at least one area of skin. The method 200 is schematically illustrated in FIG. 3a.

The method 200 may further comprise storing 211 the spectral information 10 for the at least one area of skin scanned by the shaver 100. Storing such spectral information (e.g. along with corresponding timestamps) is crucial for collecting/accumulating skin monitoring data—i.e. the (long-term) history of skin monitoring data. Besides being used in the analysis/diagnosis of the skin, skin monitoring data may serve/support developing new assessment algorithms (e.g. in terms of providing training data for machine learning algorithms).

The shaver 100 may be the shaver of the first aspect (or an embodiment thereof) and the spectral information 10 for the at least one area of the skin may originate from the at least one hyperspectral imaging sensor 101 or the plurality of hyperspectral imaging sensors 101, 102, 103, 104 of the shaver 100.

Storing 211 the spectral information 10 for the at least one area of skin scanned by the shaver 100 may comprise storing the spectral information 10 for the at least one area of skin scanned by the shaver 100 along with at least one corresponding timestamp. In so doing, and as an example, a 4-tensor comprising the spectral information (e.g. a 3-tensor) and the at least one corresponding timestamps, may arise. Evolution of the skin may be documented upon regular and/or repeated usage. As examples, timestamps may be absolute or relative in time.

The method 200 may further comprise obtaining 220 (the) data 20 measured by the one or more further sensors 130.

The method 200 may further comprise applying 230 a mapping algorithm configured to map the spectral information 10 on at least one location on the body based on the corresponding data 20 (or portions thereof) measured by the one or more further sensors 130, thereby generating a skin body landscape. The at least one location or the locations may be given in terms of an atlas of the body surface. The mapping may or may not rely on corresponding timestamps of the spectral data 10 and the data 20 measured by the one or more further sensors 130. As an example, the mapping may rely on real time image mosaicking.

The method 200 may further comprise storing 221 the data 20 measured by the one or more further sensors 130 and/or the skin body landscape. Storing the data 20 measured by the one or more further sensors 130 and/or the skin body landscape may comprise storing the data 20 measured by the one or more further sensors 130 and/or the skin body landscape along with at least one corresponding timestamp. Timestamps may, for example, be used in the mapping algorithm.

The method 200 may further comprise applying 240 a compare algorithm configured to compare the spectral information 10 for the at least one area of skin scanned by the shaver 100 to one or more corresponding instances of spectral information 11 for the at least one area of skin scanned by the shaver 100, thereby generating a comparison result 30 for the at least one area of skin scanned by the shaver 100. As an example, the compare algorithm may be a pre-trained machine learning algorithm (e.g. an artificial neural network). The one or more corresponding instances of spectral information 11 for the at least one area of the skin scanned by the shaver 100 may result from previous scans of the same at least one area of skin scanned by the shaver 100, i.e. from the (long-term) history of skin monitoring data. For example, the (long-term) history of skin monitoring data may be provided by a storage 330 of an/the electronic device 310 of a/the shaver kit 300 or by a storage 420 of a/the server 400. For example, the comparison result 30 may be a measure of difference(s). In fact, the comparison result 30 may comprise or be a binary change value (0: no change, 1: change). Alternatively, or in addition, the comparison result 30 may comprise or be a real change score in the real interval [0, 1]. Alternatively, or in addition, the comparison result 30 may comprise or be a level of confidence for assessment of the comparison. Alternatively, or in addition, the comparison result 30 may comprise or be a timeseries of change value/scores based on timestamps.

Furthermore, comparing the spectral information 10 for the at least one area of skin scanned by the shaver 100 to one or more corresponding instances of spectral information 11 for the at least one area of skin scanned by the shaver 100 may comprise comparing the data 20 measured by the one or more further sensors 130 (e.g. a hydration sensor) for the at least one area of the skin scanned by the shaver 100 to one or more corresponding instances of data measured by the one or more further sensors 130 for the at least one area of the skin scanned by the shaver 100. Also, the one or more corresponding instances of data for the at least one area of the skin scanned by the shaver 100 may result from previous scans of the same at least one area of skin scanned by the shaver 100, i.e. from the (long-term) history of skin monitoring data.

The method 200 may further comprise applying 241 an analysis algorithm configured to analyze a state of the at least one area of the skin scanned by the shaver 100 based on the spectral information 10 for the at least one area of skin scanned by the shaver 100, (the) one or more corresponding instances of spectral information 11 for the at least one area of skin scanned by the shaver 100, and/or the comparison result 30 for the at least one area of skin scanned by the shaver 100, thereby generating an analysis result 31 for the at least one area of skin scanned by the shaver 100. In other words, analyzing the state of the at least one area of the skin scanned by the shaver 100 may be based on the spectral information 10 for the at least one area of skin scanned by the shaver 100. Alternatively, or in addition, analyzing the state of the at least one area of the skin scanned by the shaver 100 may be based on (the) one or more corresponding instances of the spectral information 11 for the at least one area of skin scanned by the shaver 100. Again, as discussed above, the one or more corresponding instances of spectral information 11 for the at least one area of the skin scanned by the shaver 100 may result from previous scans of the same at least one area of skin scanned by the shaver 100, i.e. from the (long-term) history of skin monitoring data. Alternatively, or in addition, analyzing the state of the at least one area of the skin scanned by the shaver 100 may be based on the comparison result 30 (if existing, i.e. if the compare algorithm has been applied 240). In fact, the analysis algorithm may be applied 241 without applying 240 the comparison algorithm. On the other hand, incorporating the comparison result 30 may enhance the analysis.

Furthermore, analyzing the state of the at least one area of the skin scanned by the shaver 100 may be based on the data 20 measured by the one or more further sensors 130 (e.g. a hydration sensor) for the at least one area of the skin scanned by the shaver 100. Alternatively, or in addition, analyzing the state of the at least one area of the skin scanned by the shaver 100 may be based on the one or more corresponding instances of data measured by the one or more further sensors 130 for the at least one area of the skin scanned by the shaver 100 (e.g. from the history of skin monitoring data).

For example, the state of the at least one area of skin may comprise or be a measure of the hydration of the at least one area of the skin. Such a measure of hydration may e.g. be used to suggest—e.g. via the feedback trigger 33—application of hydration cream. Alternatively, or in addition, as another example, the state of the at least one area of skin may comprise or be an anomaly status of the at least one area of the skin. Alternatively, or in addition, as another example, the state of the at least one area of skin may comprise or be a derived quantity such as e.g. a level of confidence for the analysis. As an example, the analysis algorithm may be a pre-trained machine learning algorithm (e.g. an artificial neural network). For example, the analysis result 31 may be a measure of assessment of the state of the at least one area of the skin. In fact, the analysis result 31 may comprise or be a binary assessment value (0: potentially benign, 1: potentially malignant). Alternatively, or in addition, the analysis result 31 may comprise or be a real assessment score in the real interval [0, 1]. Alternatively, or in addition, the analysis result 31 may comprise or be a level of confidence for the assessment.

Alternatively, or in addition, the analysis result 31 may comprise or be a timeseries of assessment value/scores based on timestamps. Alternatively, or in addition, the analysis result 31 may comprise a data structure (e.g. 2 or 2 bits) to encode a particular finding (e.g. an inflammation, a melanoma, . . . ).

Alternatively, or in addition to analyzing a state of the at least one area of the skin scanned by the shaver 100, the method 200 may further comprise a global analysis encompassing a plurality of areas of the skin scanned by the shaver 100 (and corresponding states). For example, in so doing, an overall spectral information and/or a statistical distribution over a larger portion of the skin or over the whole surface of the skin may be obtained.

The method 200 may further comprise applying 242 a trend algorithm configured to compute a trend for a/the state of the at least one area of the skin scanned by the shaver 100 based on the spectral information 10 for the at least one area of skin scanned by the shaver 100, (the) one or more corresponding instances of spectral information 11 for the at least one area of skin scanned by the shaver 100, the comparison result 30, and/or the analysis result 31, thereby generating a trend result 32. In other words, computing the trend for the state of the at least one area of the skin scanned by the shaver 100 may be based on the spectral information 10 for the at least one area of skin scanned by the shaver 100. Alternatively, or in addition, computing the trend for the state of the at least one area of the skin scanned by the shaver 100 may be based on the one or more corresponding instances of the spectral information 11 for the at least one area of skin scanned by the shaver 100. Again, as discussed above, the one or more corresponding instances of spectral information 11 for the at least one area of the skin scanned by the shaver 100 may result from previous scans of the same at least one area of skin scanned by the shaver 100, i.e. from the (long-term) history of skin monitoring data. Alternatively, or in addition, computing the trend for the state of the at least one area of the skin scanned by the shaver 100 may be based on the comparison result 30 (if existing, i.e. if the compare algorithm has been applied 240). In fact, the trend algorithm may be applied 242 without applying 240 the comparison algorithm. On the other hand, incorporating the comparison result 30 may enhance the computation of the trend (or avoid repeating parts of the computation). Alternatively, or in addition, computing the trend for the state of the at least one area of the skin scanned by the shaver 100 may be based on the analysis result 31 (if existing, i.e. if the analysis algorithm has been applied 241). In fact, the trend algorithm may be applied 242 without applying 241 the analysis algorithm. On the other hand, incorporating the analysis result 31 may enhance the computation of the trend (or avoid repeating parts of the computation).

Furthermore, computing the trend for the state of the at least one area of the skin scanned by the shaver 100 may be based on the data 20 measured by the one or more further sensors 130 (e.g. a hydration sensor) for the at least one area of the skin scanned by the shaver 100. Alternatively, or in addition, computing the trend for the state of the at least one area of the skin scanned by the shaver 100 may be based on the one or more corresponding instances of data measured by the one or more further sensors 130 for the at least one area of the skin scanned by the shaver 100 (e.g. from the history of skin monitoring data).

As an example, whereas the analysis result 31 may relate to an assessment of the state(s) of the at least one area of the skin in the present and in the past, the trend result 32 may relate to an assessment of a future state of the at least one area of the skin. As an example, the trend algorithm may be a pre-trained machine learning algorithm (e.g. an artificial neural network).

The method 200 may further comprise applying 243 a necessity of action algorithm configured to check whether or not the spectral information 10 for the at least one area of skin scanned by the shaver 100, (the) one or more corresponding instances of spectral information 11 for the at least one area of skin scanned by the shaver 100, the comparison result 30, the analysis result 31, and/or the trend result 32 satisfies/satisfy a predetermined criterion, thereby generating a feedback trigger 33. In other words, checking may be based on the spectral information 10 for the at least one area of skin scanned by the shaver 100. Alternatively, or in addition, checking may be based on the one or more corresponding instances of spectral information 11 for the at least one area of skin scanned by the shaver 100. Alternatively, or in addition, checking may be based on the comparison result 30 (if existing, i.e. if the compare algorithm has been applied 240). In fact, the necessity of action algorithm may be applied 243 without applying 240 the comparison algorithm. Alternatively, or in addition, checking may be based on the analysis result 31 (if existing, i.e. if the analysis algorithm has been applied 241). In fact, the necessity of action algorithm may be applied 243 without applying 241 the analysis algorithm. Alternatively, or in addition, checking may be based on the trend result 32 (if existing, i.e. if the trend algorithm has been applied 242). In fact, the necessity of action algorithm may be applied 243 without applying 242 the trend algorithm.

Furthermore, checking may be based on the data 20 measured by the one or more further sensors 130 (e.g. a hydration sensor) for the at least one area of the skin scanned by the shaver 100. Alternatively, or in addition, checking may be based on the one or more corresponding instances of data measured by the one or more further sensors 130 for the at least one area of the skin scanned by the shaver 100 (e.g. from the history of skin monitoring data).

The predetermined criterion may be based on medical and/or cosmetic knowledge. It may be configured to decide whether or not an action and/or what kind of action is required. As an example, the action may be a proposal to the user of the shaver 100 to seek (professional) medical examination. As another example, the action may be a proposal to apply hydration cream to the at least one area of skin scanned by the shaver 100. As yet another example, the action may be a proposal to the user of the shaver 100 to rescan the at least one area of skin (e.g. in case of doubt and/or poor ambient conditions e.g. resulting from too much shaving cream). As an example, the predetermined criterion may comprise a mathematical expression that may or may not exceed a predetermined threshold value. On the other hand, the predetermined criterion may be more sophisticated. For example, the predetermined criterion may comprise a plurality of mathematical expressions each of which may or may not exceed a corresponding (individual) predetermined threshold value, wherein the action to be triggered requires that all predetermined (individual) threshold values be exceeded. As another example, the predetermined criterion may comprise a (binary) classifier e.g. comprising an artificial neural network, a support vector machine, and/or a linear perceptron.

The feedback trigger 33 may be binary feedback value (0: no alert, 1: alert). Alternatively, or in addition, the feedback trigger 33 may be a data structure (e.g. two or three bits) specifying a given type of feedback alert (e.g. depending on the analysis result 31). Alternatively, or in addition, the feedback trigger 33 may be a computer-readable instruction encoded in terms of a signal sequence (e.g. a bit or byte sequence). As an example, the necessity of action algorithm may be a pre-trained machine learning algorithm (e.g. an artificial neural network, a support vector machine, and/or a linear perceptron) for classification. The method 200 may further comprise sending 244 the feedback trigger 33 (e.g. via the communication interface 150) to the feedback interface 160 of the shaver 100 configured to inform the user of the shaver 100, upon receiving the feedback trigger 33, about an area of the skin that may need attention. The type of feedback (e.g. optical, acoustic, and/or haptic) may depend on the feedback trigger 33.

FIG. 3b schematically illustrate an embodiment of the computer-implemented method 200 for skin monitoring according to the second aspect.

The specification further discloses a signal sequence (e.g. a bit sequence or a byte sequence) encoding the computer-implemented method 200 for skin monitoring of the second aspect (or an embodiment thereof). The specification further discloses a storage medium configured to store the signal sequence. The storage medium may be volatile or non-volatile storage. For example, the storage medium may be RAM, ROM, EPROM, flash memory, a SSD or hard disc. When stored in the RAM, the signal sequence may be run/executed in a CPU of a computer.

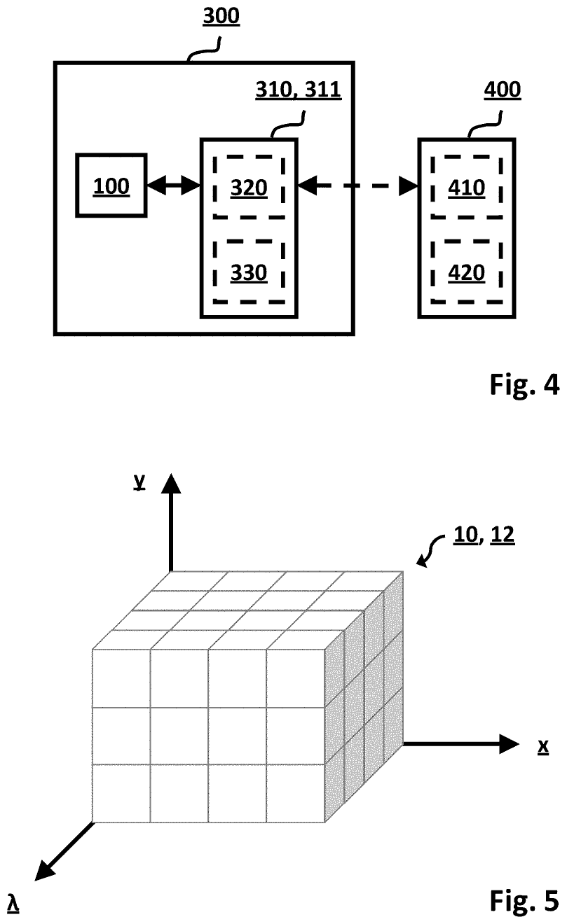

A/the shaver kit 300 comprises the shaver 100 of the first aspect (or and embodiment thereof) and an/the electronic device 310 configured for data exchange (e.g. via the communication interface of the shaver) with the shaver 100. The shaver kit 300 is schematically illustrated in FIG. 4.

The electronic device 310 may be a smart device such as e.g. a smartphone, a smart watch, a tablet, a PC. Alternatively, or in addition, the electronic device 310 may be a docking station configured to dock (or undock) the shaver 100. As an example, the docking station may be used for charging a battery of the shaver 100. Furthermore, the shaver 100 may be equipped with an intermediate storage. In this case, the docking station may allow for retarded transfer of spectral information 10 and/or data 20. Here data transfer may be triggered upon docking the shaver 100 into the docking station.

The electronic device 310 may be configured to run the computer-implemented method 200 for skin monitoring of the second aspect (or an embodiment thereof).

The electronic device 310 may be configured for data exchange with a/the server 400 in a/the network. Alternatively, or in addition, the electronic device 310 may be the server 400.

The electronic device 310 may function as a gateway 311 configured to direct data 10, 20 from the shaver 100 to the server 400 in the network and/or data 10, 20 from the server 400 in the network to the shaver 100.

The shaver kit 300 (or the electronic device 310 thereof) may comprise a user interface 320 allowing a user of the shaver kit 300 to interact with the shaver kit 300 (i.e. with the shaver 100 and/or the electronic device 310). The user of the shaver kit 300 may be e.g. the user of the shaver 100, and/or a doctor/expert examining a skin related issue and/or disease (or a skin artifact).

The electronic device 310 may be configured to receive an expert assessment corresponding to the at least one area of skin scanned by the shaver 100. As an example, the expert assessment may be made by a medical practitioner and/or dermatologist. Feeding back such an expert assessment may function as groundtruth/labels and, hence, may increase/enhance the training data for machine learning algorithms, thereby contributing to improving future models/algorithms.

The electronic device 310 may comprise a storage 330. Such a storage 330 may be used for accumulating and/or evaluating the (long-term) history of skin monitoring data.

A/the server 400 in a/the network may be configured to run the computer-implemented method 200 for skin monitoring according to the second aspect (or an embodiment thereof). As an example, the server 400 may be a cloud server on the internet. The server is schematically illustrated in FIG. 4.

The server 400 may further be configured for data exchange with a/the shaver 100 and/or with an/the electronic device 310 of a/the shaver kit 300 of the third aspect (or an embodiment thereof).

The server 400 may comprise a user interface 410 allowing a user of the server 400 to interact with the server 400. As an example, the user of the server 400 may be the user of the shaver 100 and/or a doctor/expert examining a skin related issue and/or disease (or a skin artifact). As an example, the user interface 410 may be used for telemedicine.

The server 400 may further be configured to receive an expert assessment corresponding to the at least one area of skin scanned by the shaver 100. Again, feeding back such an expert assessment may function as groundtruth/labels and, hence, may increase/enhance the training data for machine learning algorithms, thereby contributing to improving future models/algorithms. The server 400 may be used to update models/algorithms on the electronic device 310 of the shaver kit 300, thereby improving the skin monitoring analysis.

The server 400 may further comprise a storage 420. Such a storage 420 may be used for accumulating and/or evaluating the (long-term) history of skin monitoring data.

Although the present invention has been described above and is defined in the attached claims, it should be understood that the invention may alternatively be defined in accordance with the following embodiments:

1. A shaver (100) comprising:
at least one hyperspectral imaging sensor (101) configured to capture spectral information (10) for at least one area of skin scanned by the shaver (100).

2. The shaver (100) of embodiment 1, wherein the spectral information (10) comprises a three-dimensional hyperspectral data cube (12) with two spatial dimensions (x, y) spanning a scene of the at least one scanned area of the skin and one spectral dimension (λ) spanning a portion of the electromagnetic spectrum.

3. The shaver (100) of embodiment 1 or 2, wherein the spectral information (10) comprises a set of images with two spatial dimensions (x, y) spanning a scene of the at least one scanned area of the skin, wherein each image represents a unique spectral band of the electromagnetic spectrum.

4. The shaver (100) of embodiment 3, wherein the spectral information (10) comprises at least four spectral bands of the electromagnetic spectrum.

5. The shaver (100) of embodiment 3 or 4, wherein at least one spectral band of the electromagnetic spectrum comprised by the spectral information (10) is in the ultraviolet.

6. The shaver (100) of one of the embodiments 3 to 5, wherein at least one spectral band of the electromagnetic spectrum comprised by the spectral information (10) is in the visible spectrum.

7. The shaver (100) of one of the embodiments 3 to 6, wherein at least one spectral band of the electromagnetic spectrum comprised by the spectral information (10) is in the infrared.

8. The shaver (100) of one of the preceding embodiments, wherein the spectral information (10) is continuous.

9. The shaver (100) of one of the preceding embodiments, wherein the spectral information (10) for the at least one area of the skin scanned by the shaver (100) is configured for analyzing a state of the at least one area of the skin.

10. The shaver (100) of embodiment 9, wherein the state of the at least one area of the skin to be analyzed comprises a measure of the hydration of the at least one area of the skin.

11. The shaver (100) of embodiment 9 or 10, wherein the state of the at least one area of the skin to be analyzed comprises an anomaly status of the at least one area of the skin.

12. The shaver (100) of one of the preceding embodiments, wherein the at least one hyperspectral imaging sensor (101) is further configured to capture spectral information (10) for the at least one area of the skin scanned by the shaver (100) while being used for shaving.

13. The shaver (100) of embodiment 12, comprising
a shaver handle (110);
a shaving head holder (121) configured to be pivotably connected to a shaving head (122) and configured to be coupled to the shaver handle (110); and
a shaving head skin adaptor (120) configured to be coupled to the shaving head (122);

wherein the shaving head skin adaptor (120) comprises the at least one hyperspectral imaging sensor (101).

14. The shaver (100) of embodiment 13, comprising the shaving head (122).

15. The shaver (100) of embodiment 13 or 14, wherein:
the shaving head holder (121) and the shaver handle (110) are configured so as to comprise a clip-on mechanism that allows both for coupling the shaver handle (110) to the shaving head holder (121) and for decoupling the shaver handle (110) from the shaving head holder (121); and/or
the shaving head skin adaptor (120) and the shaving head (122) are configured so as to comprise a further clip-on mechanism that allows both for coupling the shaving head (122) to the shaving head skin adaptor (120) and for decoupling the shaving head (122) from the shaving head skin adaptor (120).

16. The shaver (100) of embodiment 14 or 15, wherein the at least one hyperspectral imaging sensor (101) is embedded in the shaving head skin adaptor (120) and faces the skin to be shaved by the shaver (100).

17. The shaver (100) of one of the preceding embodiments, comprising a plurality of hyperspectral imaging sensors (101, 102, 103, 104) configured to capture spectral information (10) for the at least one area of skin or a plurality of areas of skin scanned by the shaver (100).

18. The shaver (100) of embodiment 17, wherein the plurality of the hyperspectral imaging sensors (101, 102, 103, 104) comprises the at least one hyperspectral imaging sensor (101).

19. The shaver (100) of embodiment 18, when dependent on embodiment 13, wherein the shaving head skin adaptor (120) comprises the plurality of the hyperspectral imaging sensors (101, 102, 103, 104).

20. The shaver (100) of embodiment 19, wherein each hyperspectral imaging sensor (101, 102, 103, 104) of the plurality of the hyperspectral imaging sensors (101, 102, 103, 104) is embedded in the shaving head skin adaptor (120) and faces the skin to be shaved by the shaver.

21. The shaver (100) of embodiment 19 or 20, wherein the plurality of the hyperspectral imaging sensors (101, 102, 103, 104) is positioned around the shaving head (122).

22. The shaver (100) of one of the embodiments 19 to 21, wherein the shaving head skin adaptor (120) surrounds the shaving head holder (121) and/or the shaving head (122) at least partially and is sufficiently large in order for the plurality of the hyperspectral imaging sensors (101, 102, 103, 104) to be positioned around the shaving head (122).

23. The shaver (100) of one of the preceding embodiments, wherein at least one hyperspectral imaging sensor (101, 102, 103, 104) comprises:
a sensing element comprising an array of pixels each configured to capture spectral information (10) of a scene to be sensed.

24. The shaver (100) of embodiment 23, wherein at least one hyperspectral imaging sensor (101, 102, 103, 104) further comprises:
an electronic sensor unit configured to collect and/or process the spectral information (10) captured by the corresponding pixels.

25. The shaver (100) of embodiment 23 or 24, wherein at least one hyperspectral imaging sensor (101, 102, 103, 104) further comprises:
an optical system for transferring the scene to be sensed onto the corresponding sensing element.

26. The shaver (100) of one of the preceding embodiments comprising one or more further sensors (130) configured to measure one or more of:
location of the shaver (100);
orientation of the shaver (100);
stroke movement;
stroke resistance;
skin contact;
distance to the skin;
temperature;
humidity;
skin hydration.

27. The shaver (100) of embodiment 26, wherein skin contact and/or stroke movement is sensed by the one or more further sensors (130) and wherein the at least one hyperspectral imaging sensor (101, 102, 103, 104) is triggered to start capturing the spectral information (10) for the at least one area of skin scanned by the shaver (100), when skin contact and/or stroke movement has been established.

28. The shaver (100) of embodiment 26, wherein the at least one hyperspectral imaging sensor (101, 102, 103, 104) is triggered to stop capturing the spectral information (10) for the at least one area of skin scanned by the shaver (100), when skin contact and/or stroke movement has ceased.

29. The shaver (100) of one of the embodiments 26 to 28, when dependent on embodiment 13, wherein the shaver handle (110) comprises the one or more further sensors (130).

30. The shaver (100) of one of the preceding embodiments comprising an electronic control unit (ECU, 140) configured:
to power and control the at least one hyperspectral imaging sensor (101);
to obtain the spectral information (10) from at least one hyperspectral imaging sensor (101, 102, 103, 104);

wherein the shaver (100) or the electronic control unit (ECU, 140) comprises a communication interface (150) configured for data exchange with an electronic device (310), wherein the communication interface (150) is configured to transmit the spectral information (10) to the electronic device (310).

31. The shaver (100) of embodiment 30, when dependent on embodiment 26, wherein the communication interface (150) is further configured to transmit data (20) measured by the one or more further sensors (130).

32. The shaver (100) of embodiment 30 or 31, when dependent on embodiment 13, wherein the shaver handle (110) comprises the electronic control unit (ECU, 140) and/or the communication interface (150).

33. The shaver (100) of one of the preceding embodiments comprising a feedback interface (160) configured to inform a user of the shaver, upon receiving a feedback trigger (33), about an area of the skin that may need attention.

34. The shaver (100) of embodiment 33, wherein the feedback interface (160) is configured to provide optical, acoustic, and/or haptic feedback to the user of the shaver (100).

35. The shaver (100) of embodiment 33 or 34, when dependent on embodiment 13, wherein the shaver handle (110) comprises the feedback interface (160).

36. A computer-implemented method (200) for skin monitoring comprising:
obtaining (210) spectral information (10) for at least one area of skin scanned by a shaver (100).

37. The method (200) of embodiment 36, further comprising:
storing (211) the spectral information (10) for the at least one area of skin scanned by the shaver (100).

38. The method (200) of embodiment 36 or 37, wherein the shaver (100) is the shaver of one of the embodiments 1 to 35 and the spectral information (10) for the at least one area of the skin originates from the at least one hyperspectral imaging sensor (101) of the shaver (100).

39. The method (200) of embodiment 37 or 38, when dependent on embodiment 37, wherein storing (211) the spectral information (10) for the at least one area of skin scanned by the shaver (100) comprises storing the spectral information (10) for the at least one area of skin scanned by the shaver (100) along with at least one corresponding timestamp.

40. The method (200) of one of the embodiments 36 to 39, when dependent on embodiment 26, further comprising:
obtaining (220) data (20) measured by the one or more further sensors (130).

41. The method (200) of embodiment 40, further comprising:
applying (230) a mapping algorithm configured to map the spectral information (10) on at least one location on the body based on the corresponding data (20) measured by the one or more further sensors (130), thereby generating a skin body landscape.

42. The method (200) of embodiment 40 or 41, further comprising:
storing (221) the data (20) measured by the one or more further sensors (130) and/or the skin body landscape.

43. The method (200) of embodiment 42, wherein storing the data (20) measured by the one or more further sensors (130) and/or the skin body landscape comprises storing the data (20) measured by the one or more further sensors (130) and/or the skin body landscape along with at least one corresponding timestamp.

44. The method (200) of one of the embodiments 36 to 43, further comprising:
applying (240) a compare algorithm configured to compare the spectral information (10) for the at least one area of skin scanned by the shaver (100) to one or more corresponding instances of spectral information (11) for the at least one area of skin scanned by the shaver (100), thereby generating a comparison result (30) for the at least one area of skin scanned by the shaver (100).

45. The method (200) of one of the embodiments 36 to 44, further comprising:
applying (241) an analysis algorithm configured to analyze a state of the at least one area of the skin scanned by the shaver (100) based on the spectral information (10) for the at least one area of skin scanned by the shaver (100), the one or more corresponding instances of spectral information (11) for the at least one area of skin scanned by the shaver (100), and/or the comparison result (30) for the at least one area of skin scanned by the shaver (100), thereby generating an analysis result (31) for the at least one area of skin scanned by the shaver (100).

46. The method (200) of one of the embodiments 36 to 45, further comprising:
applying (242) a trend algorithm configured to compute a trend for the state of the at least one area of the skin scanned by the shaver (100) based on the spectral information (10) for the at least one area of skin scanned by the shaver (100), the one or more corresponding instances of spectral information (11) for the at least one area of skin scanned by the shaver (100), the comparison result (30), and/or the analysis result (31), thereby generating a trend result (32).

47. The method (200) of one of the embodiments 36 to 46, further comprising:
applying (243) a necessity of action algorithm configured to check whether or not the spectral information (10) for the at least one area of skin scanned by the shaver (100), the one or more corresponding instances of spectral information (11) for the at least one area of skin scanned by the shaver (100), the comparison result (30), the analysis result (31),and/or the trend result (32) satisfy a predetermined criterion, thereby generating a feedback trigger (33).

48. The method (200) of embodiment 47, when dependent on embodiment 33, further comprising:
sending (244) the feedback trigger (33) to the feedback interface (160) of the shaver (100) configured to inform the user of the shaver (100), upon receiving the feedback trigger (33), about an area of the skin that may need attention.

49. A shaver kit (300) comprising the shaver (100) of one of the embodiments 1 to 35 and an electronic device (310) configured for data exchange with the shaver (100).

50. The shaver kit (300) of embodiment 49, wherein the electronic device (310) is a smart device.

51. The shaver kit (300) of embodiment 49 or 50, wherein the electronic device (310) is a docking station configured to dock the shaver (100).

52. The shaver kit (300) of one of the embodiments 49 to 51, wherein the electronic device (310) is configured to run the computer-implemented method (200) for skin monitoring according to one of the embodiments 36 to 48.

53. The shaver kit (300) of one of the embodiments 49 to 52, wherein the electronic device (310) is configured for data exchange with a server (400) in a network.

54. The shaver kit (300) of embodiment 53, wherein the electronic device (310) functions as a gateway (311) configured to direct data from the shaver (100) to the server (400) in the network and/or data from the server (400) in the network to the shaver (100).

55. The shaver kit (300) of one of the embodiments 49 to 54, comprising a user interface (320) allowing a user of the shaver kit (300) to interact with the shaver kit (300).

56. The shaver kit (300) of embodiment 55, wherein the electronic device (310) is configured to receive an expert assessment corresponding to the at least one area of skin scanned by the shaver (100).

57. The shaver kit (300) of one of the embodiments 49 to 56, wherein the electronic device (310) comprises a storage (330).

58. A server (400) in a network configured to run the computer-implemented method (200) for skin monitoring according to one of the embodiments 36 to 48.

59. The server (400) of embodiment 58, configured for data exchange with a shaver (100) and/or with an electronic device (310) of a shaver kit (300) according to one of the embodiments 49 to 57.

60. The server (400) of embodiment 58 or 59, comprising a user interface (410) allowing a user of the server (400) to interact with the server (400).

61. The server (400) of embodiment 60, configured to receive an expert assessment corresponding to the at least one area of skin scanned by the shaver (100).

62. The server (400) of one of the embodiments 58 to 61, comprising a storage (420).

### REFERENCE NUMERALS

10 spectral information

11 one or more instances of spectral information

12 three-dimensional hyperspectral data cube

20 data measured by one or more further sensors

30 comparison result

31 analysis result

32 trend result

33 feedback trigger

100 shaver

101-104 hyperspectral imaging sensor(s)

110 shaver handle

120 shaving head skin adaptor

121 shaving head holder

122 shaving head

130 one or more further sensor(s)

140, ECU electronic control unit

150 communication interface

160 feedback interface

200 computer-implemented method for skin monitoring

210 obtaining spectral information for at least one area of skin scanned by a shaver

211 storing the spectral information for at least one area of skin scanned by a shaver

220 obtaining data measured by one or more further sensors

221 storing the data measured by one or more further sensors and/or the skin body landscape

230 applying a mapping algorithm

240 applying a compare algorithm

241 applying an analysis algorithm

242 applying a trend algorithm

243 applying a necessity of action algorithm

244 sending the feedback trigger to the feedback interface of the shaver

300 shaver kit

310 electronic device

311 gateway

320 user interface (of the shaver kit)

330 storage (of the shaver kit)

400 server

410 user interface (of the server)

420 storage (of the server)

x, y two spatial dimensions spanning a scene of at least one scanned area of skin

λ one spectral dimension spanning a portion of the electromagnetic spectrum

1. A shaver comprising:
at least one hyperspectral imaging sensor configured to capture spectral information for at least one area of skin scanned by the shaver.

2. The shaver of claim 1, wherein the spectral information comprises a three-dimensional hyperspectral data cube with two spatial dimensions spanning a scene of the at least one scanned area of the skin and one spectral dimension spanning a portion of the electromagnetic spectrum.

3. The shaver of claim 1, wherein the spectral information comprises a set of images with two spatial dimensions spanning a scene of the at least one scanned area of the skin, wherein each image represents a unique spectral band of the electromagnetic spectrum.

4. The shaver of claim 1, wherein the at least one hyperspectral imaging sensor is further configured to capture spectral information for the at least one area of the skin scanned by the shaver while being used for shaving.

5. The shaver of claim 1, comprising
a shaver handle;
a shaving head holder configured to be pivotably connected to a shaving head and configured to be coupled to the shaver handle; and
a shaving head skin adaptor configured to be coupled to the shaving head;
wherein the shaving head skin adaptor comprises the at least one hyperspectral imaging sensor.

6. The shaver of claim 1, comprising a plurality of hyperspectral imaging sensors configured to capture spectral information for the at least one area of skin or a plurality of areas of skin scanned by the shaver, wherein the plurality of the hyperspectral imaging sensors comprises the at least one hyperspectral imaging sensor.

7. The shaver of claim 6, wherein the shaving head skin adaptor comprises the plurality of the hyperspectral imaging sensors, and wherein the plurality of the hyperspectral imaging sensors is positioned around the shaving head.

8. The shaver of claim 1, further comprising a feedback interface configured to inform a user of the shaver, upon receiving a feedback trigger, about an area of the skin that may need attention.

9. The shaver of claim 5, wherein:
the shaving head holder and the shaver handle are configured so as to comprise a clip-on mechanism that allows both for coupling the shaver handle to the shaving head holder and for decoupling the shaver handle from the shaving head holder; and/or
the shaving head skin adaptor and the shaving head are configured so as to comprise a further clip-on mechanism that allows both for coupling the shaving head to the shaving head skin adaptor and for decoupling the shaving head from the shaving head skin adaptor,
wherein the at least one hyperspectral imaging sensor is embedded in the shaving head skin adaptor and faces the skin to be shaved by the shaver.

10. The shaver of claim 1, wherein at least one hyperspectral imaging sensor comprises:
a sensing element comprising an array of pixels each configured to capture spectral information of a scene to be sensed.

11. The shaver of claim 1 comprising one or more further sensors configured to measure one or more of:
location of the shaver;
orientation of the shaver;
stroke movement;
stroke resistance;
skin contact;
distance to the skin;
temperature;
humidity; and
skin hydration.

12. A computer-implemented method for skin monitoring comprising:
obtaining spectral information for at least one area of skin scanned by a shaver;
storing the spectral information for the at least one area of skin scanned by the shaver.

13. The method of claim 12, wherein the shaver comprises at least one hyperspectral imaging sensor configured to capture spectral information for at least one area of skin scanned by the shaver, and the spectral information for the at least one area of the skin originates from the at least one hyperspectral imaging sensor of the shaver.

14. The method of claim 12, further comprising:
applying a compare algorithm configured to compare the spectral information for the at least one area of skin scanned by the shaver to one or more corresponding instances of spectral information for the at least one area of skin scanned by the shaver, thereby generating a comparison result for the at least one area of skin scanned by the shaver.

15. The method of claim 12, further comprising:
applying an analysis algorithm configured to analyze a state of the at least one area of the skin scanned by the shaver based on the spectral information for the at least one area of skin scanned by the shaver, the one or more corresponding instances of spectral information for the at least one area of skin scanned by the shaver, and/or the comparison result for the at least one area of skin scanned by the shaver, thereby generating an analysis result for the at least one area of skin scanned by the shaver;
applying a trend algorithm configured to compute a trend for the state of the at least one area of the skin scanned by the shaver based on the spectral information for the at least one area of skin scanned by the shaver, the one or more corresponding instances of spectral information for the at least one area of skin scanned by the shaver, the comparison result, and/or the analysis result, thereby generating a trend result.

16. The method of claim 12, further comprising:
applying a necessity of action algorithm configured to check whether or not the spectral information for the at least one area of skin scanned by the shaver, the one or more corresponding instances of spectral information for the at least one area of skin scanned by the shaver, the comparison result, the analysis result, and/or the trend result satisfy a predetermined criterion, thereby generating a feedback trigger.

17. The method of claim 16, further comprising:
sending the feedback trigger to the feedback interface of the shaver configured to inform the user of the shaver, upon receiving the feedback trigger, about an area of the skin that may need attention.

18. The method of claim 12, wherein the shaver comprises one or more further sensors, further comprising:
obtaining data measured by the one or more further sensors.

19. The method of claim 18, further comprising:
applying a mapping algorithm configured to map the spectral information on at least one location on the body based on the corresponding data measured by the one or more further sensors, thereby generating a skin body landscape.

20. A shaver kit comprising the shaver of claim 1 and an electronic device configured for data exchange with the shaver, wherein the electronic device is configured to run a computer-implemented method for skin monitoring comprising: obtaining spectral information for at least one area of skin scanned by a shaver; and storing the spectral information for the at least one area of skin scanned by the shaver.
